(19) United States
(12) Patent Application Publication
(10) Pub. No.: US 2025/0378325 A1
(43) Pub. Date: Dec. 11, 2025

(54) COMPACT MODELING METHOD AND COMPUTING DEVICE FOR MEMORY USING NEURAL NETWORK

(71) Applicant: ALSEMY INC., Seoul (KR)

(72) Inventors: Ye Sle CHA, Ansan-si (KR); Hyun Seok WHANG, Seoul (KR); Jongwook JEON, Suwon-si (KR); Premkumar VINCENT, Osan-si (KR)

(73) Assignee: ALSEMY INC., Seoul (KR)

(21) Appl. No.: 19/209,083

(22) Filed: May 15, 2025

(30) Foreign Application Priority Data
May 16, 2024 (KR) 10-2024-0063921

(51) Int. Cl. G06N 3/08

(52) U.S. Cl. CPC G06N 3/08

(57) ABSTRACT

Disclosed is a compact modeling method for a memory using a neural network performed by a processor. The compact modeling method for a memory using a neural network includes updating a hidden state at time tₙ₊₁ by applying a voltage of the memory, a conductance of the memory, and the hidden state approximated at time tₙ₊₁ to a gated recurrent unit (GRU) cell, and predicting a conductance of the memory at time tₙ₊₁ by applying the voltage, the conductance, and the updated hidden state to a multilayer perceptron (MLP).

### CROSS-REFERENCE TO RELATED APPLICATION

This application claims priority to and the benefit of Korean Patent Application No. 10-2024-0063921, filed on May 16, 2024, the disclosure of which is incorporated herein by reference in its entirety.

### BACKGROUND

### 1. Field of the Invention

The present invention relates to a compact modeling method and a computing device for a memory using a neural network, and more particularly, to a compact modeling method and a computing device for a memory using a new data-driven neural network.

### 2. Discussion of Related Art

A resistive random access memory (RRAM) is a non-volatile memory that is operated by changing the resistance of a solid-state dielectric material. In-memory computing and high-capacity memory can be achieved using an RRAM.

In neuromorphic systems that mimic the functions of the human brain, an RRAM functions as a synaptic device. That is, the conductance of an RRAM is gradually adjusted according to external voltages.

Therefore, it is essential to verify transient programming pulse conditions that vary over time as well as to characterize the DC butterfly curve. In response to transient voltage pulses, both resistance switching and gradual conductance adjustment occur, motivating the development of compact models that reflect the long-term potentiation (LTP) and long-term depression (LTD) characteristics of an RRAM.

However, equation-based compact models have limitations due to the variety of materials and complex conduction mechanisms in an RRAM. As a result, data-driven compact models using neural networks have emerged, but a neural network-based compact model that accurately predicts both LTP and LTD characteristics has not yet been developed.

Therefore, a new neural network-based compact model that can accurately model the characteristics of RRAM devices such as LTP/LTD is proposed. In addition, this compact model can accurately predict voltage-current characteristics that exhibit hysteresis loops.

### SUMMARY OF THE INVENTION

The present invention is directed to a compact modeling method and a computing device for a memory using a new data-driven neural network.

According to an aspect of the present invention, there is provided a compact modeling method for a memory using a neural network performed by a processor, which includes: updating a hidden state at time tₙ₊₁ by applying a voltage of the memory, a conductance of the memory, and the hidden state approximated at time tₙ₊₁ to a gated recurrent unit (GRU) cell; and predicting a conductance of the memory at time tₙ₊₁ by applying the voltage, the conductance, and the updated hidden state to a multilayer perceptron (MLP).

According to an embodiment, the compact modeling method for memory using the neural network may further include approximating an instantaneous change in the hidden state of the neural network used in compact modeling for the memory by applying a voltage of the memory at time tₙ₊₁ and conductance of the memory at time tₙ to a fully connected layer.

The conductance predicted at time tₙ₊₁ may be applied to the fully connected layer at the next time step.

According to an embodiment, the compact modeling method for memory using the neural network may further include generating input training data by randomly sampling an input pulse voltage at irregular time intervals in an arbitrary number of samplings in a width and rise/fall time of the input pulse voltage to train the neural network.

The memory may be a resistive random access memory (ReRAM).

According to another aspect of the present invention, there is provided a computing device including: a processor configured to execute compact modeling commands for a ReRAM using a neural network; and a memory configured to store the commands.

The commands may be implemented to update a hidden state at time tₙ₊₁ by applying a voltage of the ReRAM, a conductance of the ReRAM, and the hidden state approximated at time tₙ₊₁ to a GRU cell, and predict a conductance of the ReRAM at time tₙ₊₁ by applying the voltage, the conductance, and the updated hidden state to an MLP.

The commands may be further implemented to approximate an instantaneous change in the hidden state of the neural network used in the compact modeling for the ReRAM by applying the voltage of the memory at time tₙ₊₁ and conductance of the ReRAM at time tₙ to a fully connected layer.

The conductance predicted at time tₙ₊₁ may be applied to the fully connected layer at the next time step.

The commands may be further implemented to generate input training data by randomly sampling an input pulse voltage at irregular time intervals in an arbitrary time of samplings in a width and rise/fall time of the input pulse voltage to train the neural network.

The neural network may include an input layer including a voltage of the ReRAM at time tₙ₊₁ and a conductance of the ReRAM at time tₙ, a hidden layer including the GRU cell, and an output layer including the conductance of the ReRAM at time tₙ₊₁.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a current graph for voltage of a memory cell of a resistive random access memory (RRAM);

FIG. 2 is a block diagram illustrating a computing device for performing a compact modeling method for a memory using a neural network according to an embodiment of the present invention;

FIG. 3 is a block diagram illustrating a neural network for implementing a compact model for a memory according to an embodiment of the present invention;

FIG. 4 is a block diagram illustrating the internal structure of one of multiple GRU blocks illustrated in FIG. 3;

FIG. 5 is a flowchart illustrating a compact modeling method for a memory using a neural network according to an embodiment of the present invention;

FIGS. 6A and 6B are graphs showing a conductance prediction for time of a neural network according to an embodiment of the present invention;

FIGS. 7A, 7B, 7C, and 7D are graphs showing a conductance prediction for an input voltage pulse of a neural network according to an embodiment of the present invention; and

FIGS. 8A, 8B, and 8C are other graphs showing a conductance prediction for time of a neural network according to an embodiment of the present invention.

### DETAILED DESCRIPTION OF EXEMPLARY EMBODIMENTS

Specific structural or functional descriptions of embodiments according to the concept of the present invention disclosed in the present specification are merely exemplified for describing the embodiments according to the concept of the present invention, and the embodiments according to the concept of the present invention may be implemented in various forms and are not limited to the embodiments described in the present specification.

Since the embodiments according to the concept of the present invention may be variously changed and may have various forms, the embodiments will be illustrated in the drawings and described in detail in the present specification. However, the embodiments according to the concept of the present invention are not intended to be limited to specific disclosed forms, and include all changes, equivalents, and substitutes included in the spirit and scope of the present invention.

Terms such as “first,” “second,” etc., may be used to describe various components, but the components are not to be construed as being limited to the terms. The terms are used only to distinguish one component from another component. For example, a “first” component may be called a “second” component and a “second” component may also be similarly called a “first” component without departing from the scope of the present invention.

It is to be understood that when a first component is referred to as being “connected to” or “coupled to” a second element, it may be connected or coupled directly to the second element or be connected to or coupled to the second element with a third element intervening therebetween. On the other hand, it is to be understood that when a first element is referred to as being “connected directly to” or “coupled directly to” a second element, it is connected or coupled to the second element with no other element intervening therebetween. Other expressions describing a relationship between components, such as “between,” “directly between,” “neighboring,” “directly neighboring,” and the like, should be similarly interpreted.

Terms used in the present specification are used only in order to describe specific exemplary embodiments rather than limiting the present invention. In the present specification, singular forms are intended to include plural forms unless the context clearly indicates otherwise. The terms “comprise” and “have” used in this specification specify the presence of stated features, numerals, steps, operations, components, parts, or a combination thereof, but do not preclude the presence or addition of one or more other features, numerals, steps, operations, components, parts, or a combination thereof.

The terms used in the present application are merely used to describe particular embodiments and are not intended to limit the present invention. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equivalent to the contextual meanings in the relevant field of art and are not to be interpreted to have ideal or excessively formal meanings unless clearly defined in the present application.

Hereinafter, the present invention will be described in detail by explaining preferred embodiments of the present invention with reference to the attached drawings.

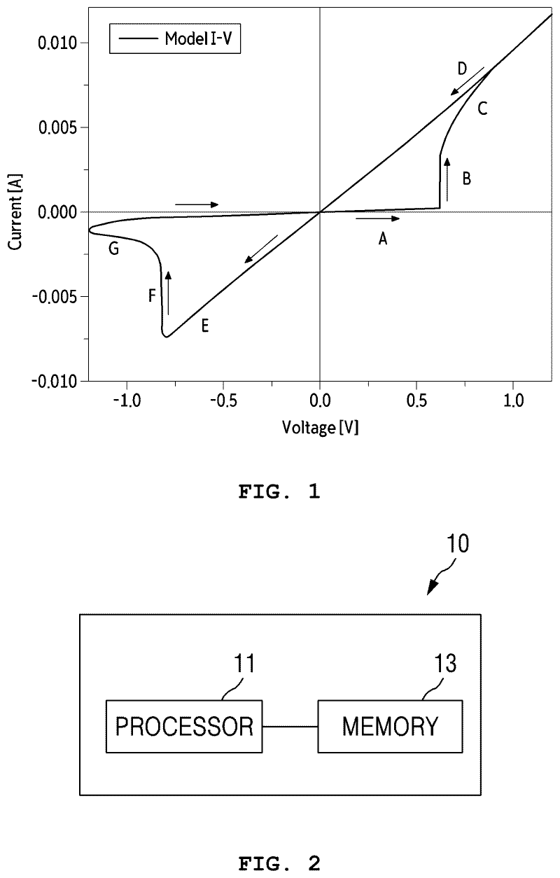

FIG. 1 is a current graph for voltage of a memory cell of a resistive random access memory (RRAM).

Referring to FIG. 1, the hysteresis behavior of current-voltage characteristics of a filament type is illustrated. In FIG. 1, A, B, C, D, E, F, G, and H represent filament stages.

A represents a high resistance state (HRS), B represents a completion state, C represents an expansion state, D and E represent a low resistance state (LRS), F represents a partial dissolution state, G represents a rupture state, and H represents an HRS. That is, the hysteresis behavior (hysteresis loop) illustrated in FIG. 1 appears due to the physical characteristics of the RRAM device.

A set voltage Vset is a positive voltage. The set voltage Vset is a point where the graph of FIG. 1 bends at a positive voltage, that is, a point where the positive voltage changes from A to B. A reset voltage Vreset is a negative voltage. The reset voltage Vreset is a point where the graph of FIG. 1 bends at a negative voltage, that is, a point where the negative voltage changes from E to F.

An RRAM includes multiple memory cells (not shown). An RRAM can be called various names such as RRAM device, ReRAM, ReRAM device, or resistive switching device. FIG. 1 is a current-voltage graph for a memory cell of a bipolar RRAM.

As shown in the graph in FIG. 1, there are limitations to equation-based compact modeling of various physical characteristics of an RRAM. In addition, a variety of materials can be used to fabricate RRAM devices, and the physical properties of the devices vary depending on the material used. It is significantly difficult to develop equation-based compact modeling that can model all of these variations.

Therefore, a data-driven compact modeling method using a neural network to explain the characteristics of an RRAM such as the unique pinch hysteresis loop illustrated in FIG. 1 and the possible intermediate conducting states controlled by the input voltage pulse is disclosed in the present invention. The compact modeling method refers to a compact modeling method for an RRAM.

FIG. 2 is a block diagram illustrating a computing device for performing a compact modeling method for a memory using a neural network according to an embodiment of the present invention.

Referring to FIG. 2, a computing device 10 for performing a compact modeling method for a memory using a neural network may be an electronic device such as a server, a computer, a notebook, a tablet PC, or a personal PC. The memory is an RRAM.

The computing device 10 includes a processor 11 and a memory 13. The processor 11 executes compact modeling commands for a memory using a neural network. The memory 13 stores the commands. Hereinafter, a compact modeling method for a memory using a neural network will be disclosed.

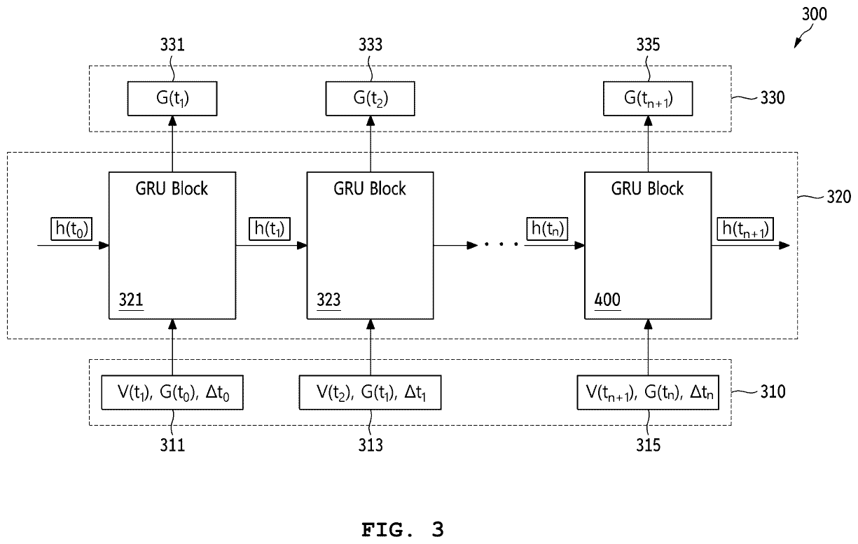

FIG. 3 is a block diagram illustrating a neural network for implementing a compact model for a memory according to an embodiment of the present invention.

Referring to FIGS. 2 and 3, the compact model for a memory is implemented as a neural network 300. The neural network 300 for implementing the compact model for a memory includes an input layer 310, a hidden layer 320, and an output layer 330.

The input layer 310 includes multiple inputs 311, 313, and 315.

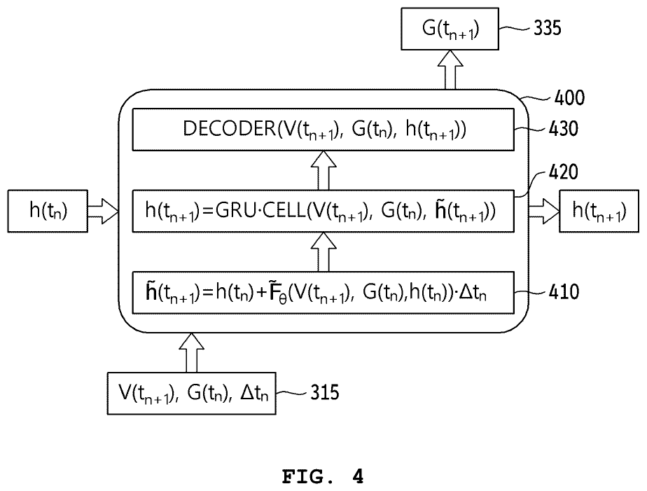

The hidden layer 320 includes multiple GRU blocks 321, 323, and 400. The GRU blocks 321, 323, and 400 will be described in detail in FIG. 4.

The output layer 330 includes multiple outputs 331, 333, and 335.

Depending on the embodiment, the number of the multiple inputs 311, 313, and 315 included in the input layer 310, the number of the multiple GRU blocks 321, 323, and 400 included in the hidden layer 320, and the number of the multiple outputs 331, 333, and 335 included in the output layer 330 may vary.

FIG. 4 is a block diagram illustrating the internal structure of one of the multiple GRU blocks illustrated in FIG. 3.

Referring to FIGS. 2 to 4, since the operations and functions of the multiple GRU blocks are all the same or similar, the GRU block 400 is described as a representative example.

The GRU block 400 receives a voltage of a memory at time tₙ₊₁ and a conductance of the memory at time tₙ, and outputs the conductance of the memory at time tₙ₊₁ and a hidden state at time tₙ₊₁. The memory is an RRAM.

The GRU block 400 includes an ordinary differential equations (ODE) layer 410, a GRU layer 420, and a decoder layer 430. The ODE layer 410, the GRU layer 420, and the decoder layer 430 are implemented as fully connected layers. According to an embodiment, the ODE layer 410, the GRU layer 420, and the decoder layer 430 may be a multilayer perceptron (MLP). The operations of the ODE layer 410, the GRU layer 420, and the decoder layer 430 are performed by the processor 11.

Hereinafter, the operations of the ODE layer 410, the GRU layer 420, and the decoder layer 430 will be described.

The specific operation of the ODE layer 410 is as follows.

An input 315 including a voltage V(tₙ₊₁) applied to the memory at time tₙ₊₁, a conductance G(tₙ) of the memory at time tₙ, and a difference Δtₙ between time tₙ₊₁ and time tₙ is applied to the GRU block 400. Here, t denotes time, and n denotes an integer greater than or equal to 0.

The processor 11 approximates the hidden state h(tₙ₊₁) of the neural network 300 used in compact modeling of the memory at time tₙ₊₁ by using the voltage V(tₙ₊₁) applied to the memory at time tₙ, the conductance G(tₙ) of the memory at time tₙ, and the difference Δtₙ between time tₙ₊₁ and time tₙ. The hidden state h(tₙ₊₁) of the neural network 300 represents the resistance state of the memory, that is, the RRAM. The RRAM has a conducting filament that changes depending on an input voltage. Therefore, the conductivity changes. The current characteristic for the voltage depends on the resistance state of the RRAM.

The approximation of the hidden state of the neural network 300 can be calculated as shown in the following Equation 1.

$$\tilde{h} ( {t}_{n + 1} ) = h ( {t}_{n} ) + {\tilde{F}}_{θ} ( V ( {t}_{n + 1} ) , G ( {t}_{n} ) , h ( {t}_{n} ) ) \cdot Δ {t}_{n} \qquad [ Equation 1 ]$$

Here, \tilde{h}(tₙ₊₁) denotes the approximation of the hidden state at time tₙ₊₁ of the neural network 300, h(tₙ) denotes the hidden state at time tₙ of the neural network 300, \tilde{F}ₑ(V(tₙ₊₁), G(tₙ), h(tₙ)) denotes the approximation of the time-dependent change rate of the hidden state through the voltage V(ₜₙ₊₁) applied to the memory at time tₙ₊₁, the conductance G(tₙ) of the memory at time tₙ, and the hidden state h(tₙ) at time tₙ, and Δtₙ denotes a difference between time tₙ₊₁ and time tₙ.

\tilde{F}_{θ}( ) is a multi-layer perceptron (MLP) which expresses ordinary differential equations satisfied by the hidden state. The voltage V(ₜₙ₊₁), the conductance G(tₙ), and the hidden state h(tₙ) are the inputs of MLP. \tilde{F}_{θ}( ) is learned.

In other words, the processor 11 may apply the voltage V(tₙ₊₁) applied to the memory at time tₙ₊₁, the conductance G(tₙ) of the memory at time tₙ, and the difference Δtₙ between time tₙ₊₁ and time tₙ to an ODE layer 410 implemented with a neural network algorithm to approximate the instantaneous change in the hidden state of the neural network 300 used in the compact modeling for the memory. The instantaneous change in the hidden state of the neural network 300 can be expressed by the following equation.

$$\frac{( \tilde{h} ( {t}_{n + 1} ) = h ( {t}_{n} ) )}{Δ {t}_{n}} = {\tilde{F}}_{θ} ( V ( {t}_{n + 1} ) , G ( {t}_{n} ) , h ( {t}_{n} ) ) \qquad [ Equation 2 ]$$

Here,

$$\frac{( \tilde{h} ( {t}_{n + 1} ) = h ( {t}_{n} ) )}{Δ {t}_{n}}$$

denotes the approximation of the instantaneous change in the hidden state of the neural network 300. The instantaneous change in the hidden state of the neural network 300 can be approximated by the ODE layer 410. The input of the ODE layer 410 is the voltage of the memory at time tₙ₊₁ V(tₙ₊₁), the conductance of the memory at time tₙ G(tₙ), and the hidden state at time tₙ h(tₙ), and the output thereof is

$$\frac{( \tilde{h} ( {t}_{n + 1} ) = h ( {t}_{n} ) )}{Δ {t}_{n}}$$

The reason for using the ODE layer 410 is to cope with input sequences with irregular time intervals. That is, continuous-time hidden dynamics can be obtained by using the ODE layer 410 implemented with the neural network algorithm. The approximation of the instantaneous change in the hidden state means continuous-time hidden dynamics. Therefore, the conductance change in the input voltage can be effectively modeled.

The ODE layer 410 is disclosed in the paper “Neural Ordinary Differential Equations” (RTQ Chen 2018) and the paper “Latent ODEs for Irregularly-Sampled Time Series” (Y Rubanova 2019). That is, the ODE layer 410 implemented with the neural network algorithm is the neural ODE disclosed in the paper “Neural Ordinary Differential Equations” (RTQ Chen 2018) or the paper “Latent ODEs for Irregularly-Sampled Time Series” (Y Rubanova 2019). The ODE layer 410 is a widely known neural network algorithm used to implement the neural ODE. For example, the ODE layer 410 may be an MLP including 6 hidden layers and 128 hidden nodes. In Equation 2, θ denotes a parameter in the MLP. However, a difference is that the input and output of the ODE layer 410 are different from those in the previously published papers.

The specific operation of a GRU layer 420 is as follows.

The processor 11 applies the voltage V(tₙ₊₁) applied to the memory, the conductance G(tₙ) of the memory, and the hidden state \tilde{h}(tₙ₊₁) approximated at time tₙ₊₁ to a gated recurrent unit (GRU) cell to update the hidden state at time tₙ₊₁.

The update operation of the hidden state can be expressed as the following equation.

$$h ( {t}_{n + 1} ) = GRU \cdot CELL ( V ( {t}_{n + 1} ) , G ( {t}_{n} ) , \tilde{h} ( {t}_{n + 1} ) ) \qquad [ Equation 3 ]$$

Here, GRU·CELL denotes a function of the GRU cell disclosed in the paper, V(tₙ₊₁) denotes the voltage of the memory at time tₙ₊₁, G(tₙ) denotes the conductance of the memory, \tilde{h}(tₙ₊₁) denotes the approximation of the hidden state of the neural network 300 at time tₙ₊₁, and h(tₙ₊₁) denotes an updated hidden state.

That is, the GRU layer 420 receives the voltage V(tₙ₊₁) applied to the memory at time tₙ₊₁, the conductance G(tₙ) of the memory, and the approximation \tilde{h}(tₙ₊₁) of the hidden state of the neural network 300 at time tₙ₊₁, and outputs the updated hidden state h(tₙ₊₁). The GRU layer 420 may include two hidden layers. The GRU cell is the GRU layer 420.

The GRU cell is a concept introduced in the paper “Learning Phrase Representations using RNN Encoder-Decoder for Statistical Machine Translation” (Kyunghyun Cho 2014). In this invention, the GRU cell uses the concept used in already published papers such as the paper “Are GRU Cells More Specific and LSTM Cells More Sensitive in Motive Classification of Text” (Nicole Gruber, 2020). However, the difference is that the input and output of the GRU cell are different from those in the previously published papers.

The reason for using the GRU cell is that long serial data can be processed efficiently.

The specific operation of the decoder layer 430 is as follows. The decoder layer 430 can be implemented as an MLP.

The processor 11 applies the voltage V(tₙ₊₁), the conductance G(tₙ), and updated hidden state h(tₙ₊₁) to the decoder layer 430 to predict the conductance G(tₙ₊₁) of the memory at time tₙ₊₁. The conductance prediction operation is as follows.

$$G ( {t}_{n + 1} ) = DECODER ( V ( {t}_{n + 1} ) , G ( {t}_{n} ) , h ( {t}_{n + 1} ) ) \qquad [ Equation 4 ]$$

Here, DECODER denotes a decoder layer 430, V(tₙ₊₁), G(tₙ), and h(tₙ₊₁) denote inputs of the decoder layer 430, and G(tₙ₊₁) denotes an output of the decoder layer 430. That is, the decoder layer 430 receives the voltage V(tₙ₊₁), the conductance G(tₙ), and the updated hidden state h(tₙ₊₁), and outputs the conductance G(tₙ₊₁) of the memory at the time tₙ₊₁. According to an embodiment, instead of V(tₙ₊₁), G(tₙ), and h(tₙ₊₁), V(tₙ₊₁) and h(tₙ₊₁) may be input to the decoder layer 430.

The conductance G(tₙ₊₁) of the memory at time tₙ₊₁ is input to the GRU block at the next time step. Specifically, the conductance G(tₙ₊₁) predicted at time tₙ₊₁ is applied to the ODE layer at the next time step tₙ₊₂.

The processor 11 outputs the conductance instead of the current.

The MLP may include 3 hidden layers and 128 hidden nodes.

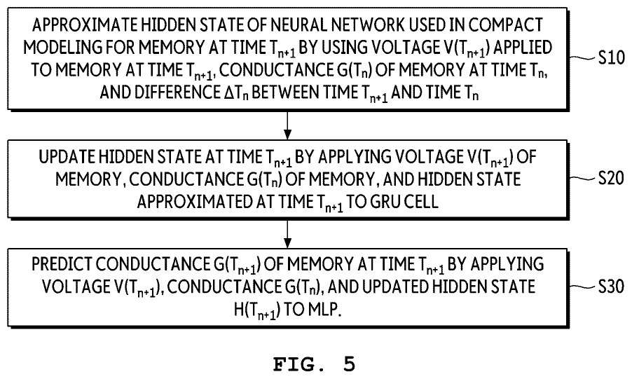

FIG. 5 is a flowchart illustrating a compact modeling method for a memory using a neural network according to an embodiment of the present invention.

Referring to FIGS. 2 to 5, in operation 10, the processor 11 approximates the hidden state h(tₙ₊₁) of the neural network 300 used in compact modeling of the memory at time tₙ₊₁ by using the voltage V(tₙ₊₁) applied to the memory at time tₙ₊₁, the conductance G(tₙ) of the memory at time tₙ, and the difference Δtₙ between time tₙ₊₁ and time tₙ.

In operation S20, the processor 11 updates the hidden state at time tₙ₊₁ by applying the voltage V(tₙ₊₁) applied to the memory, the conductance G(tₙ) of the memory, and the hidden state \tilde{h}(tₙ₊₁) approximated at time tₙ₊₁ to the GRU cell.

In operation S30, the processor 11 predicts the conductance G(tₙ₊₁) of the memory at time tₙ₊₁ by applying the voltage V(tₙ₊₁), the conductance G(tₙ), and the updated hidden state h(tₙ₊₁) to the MLP.

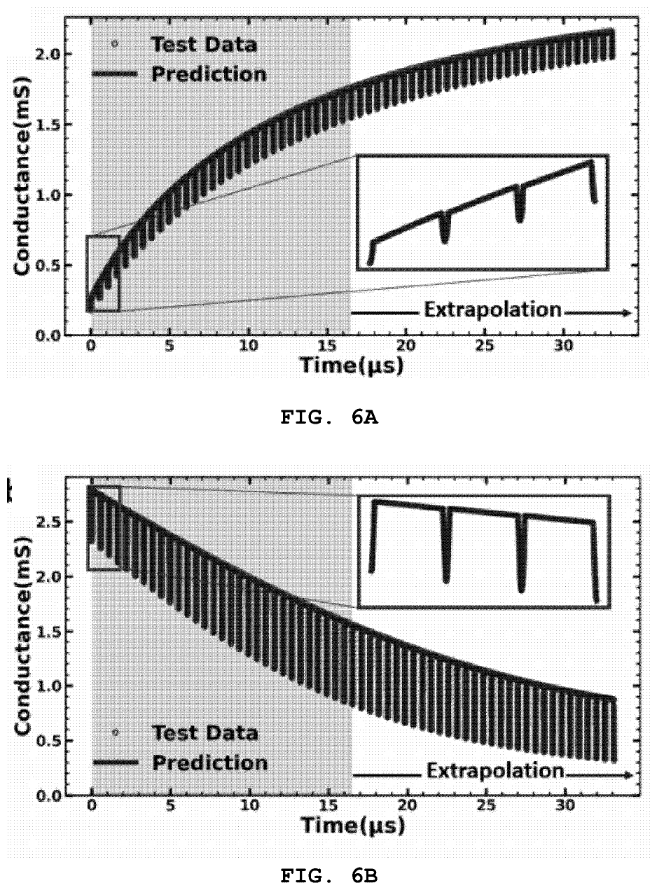

FIGS. 6A and 6B are graphs showing a conductance prediction for time of a neural network according to an embodiment of the present invention. In FIGS. 6A and 6B, the curves represent the conductance over time according to the prediction of the neural network 300, and the dots under the curves in FIGS. 6A and 6B represent unseen test data. FIG. 6A represents LTP characteristics, and FIG. 6B represents LTD characteristics. The shaded areas represent observed areas, and the unshaded areas represent extrapolation areas.

Referring to FIGS. 6A and 6B, the test data reflects various input voltage pulse conditions. Set voltages Vset are 0.95 V, 1.05 V, and 1.15 V, reset voltages Vreset are −2.3 V and −2.4 V, pulse widths are 250 ns and 500 ns, and pulse rise/fall times are 10 ns, 25 ns, and 50 ns. The test data is used after the neural network 300 is trained.

FIG. 6A shows a case where the number of input voltage pulses is 60, the set voltage Vset is 1.15 V, the width is 500 ns, and the rise/fall time is 25 ns. FIG. 6B shows a case where the number of input voltage pulses is 60, the reset voltage Vreset is −2.4 V, the width is 500 ns, and the rise/fall time is 25 ns.

Table 1 shows the test accuracy of the neural network 300 when the number of input voltage pulses increases. The input voltage pulse means the voltage of the RRAM input to the GRU layer 320 in FIG. 3.

TABLE 1

Relative linear error (%)
depending on number of input
voltage pulses

| | 30 | 60 | 90 | 120 |
|---|---|---|---|---|
| LTP | 0.78 | 1.13 | 1.40 | 1.67 |
| LTD | 0.47 | 1.21 | 2.74 | 4.63 |
| Average | 0.57 | 1.19 | 2.30 | 3.64 |

In Table 1, when the number of input voltage pulses is 30, an average relative linear error is 0.57%, and the average relative linear error gradually increases with an increase in the number of input voltage pulses. However, the neural network 300 still maintains high accuracy even when the number of input voltage pulses is 120. Referring to FIGS. 6A and 6B, the neural network 300 shows excellent accuracy in fitting LTP and LTD characteristics.

Training data is required to train the neural network 300. The input pulse voltage and conductance are used as the training data. The input pulse voltage is input training data, and the conductance is output training data. The input pulse voltage is a voltage of the memory at an arbitrary time. When the time is 0, the corresponding input pulse voltage is applied to the neural network 300, and the conductance corresponding to the initial time is output. The waveform of the input pulse voltage may be generated in various ways by a pulse generator.

The processor 11 randomly samples the input pulse voltage at irregular time intervals in an arbitrary number of samplings in the rise/fall time of the input pulse voltage to generate input training data. By randomly sampling the input pulse voltage at irregular time intervals in the arbitrary number (e.g., 80) of samplings in the rise/fall time of the input pulse voltage to generate input training data, it is possible to apply the ODE layer 420 to an input voltage sequence with an irregular time interval. When the input training data is too long, training of the neural network 300 may be difficult. According to an embodiment, the processor 11 may randomly sample the input pulse voltage at irregular time intervals in the arbitrary number (e.g., 80) of samplings in the width of the input pulse voltage to generate the input training data. In addition, according to an embodiment, the processor 11 may randomly sample the input pulse voltage at irregular time intervals in the arbitrary number of samplings in the width and rise/fall time of the input pulse voltage to generate input learning data.

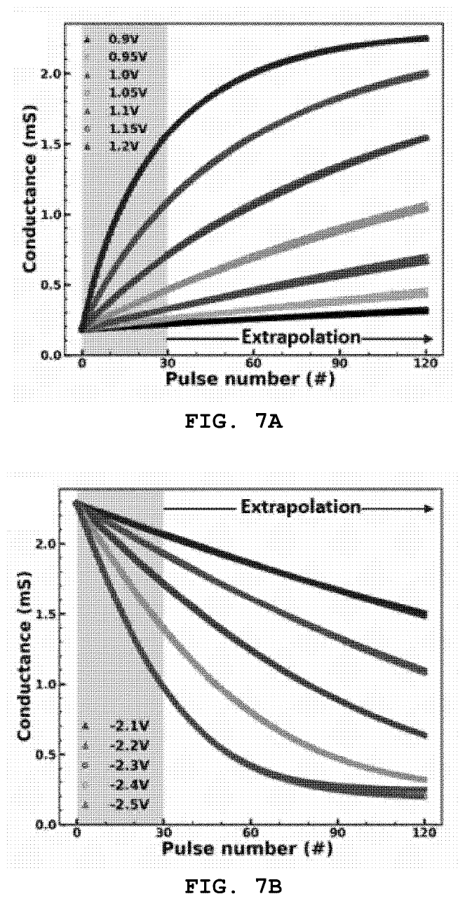

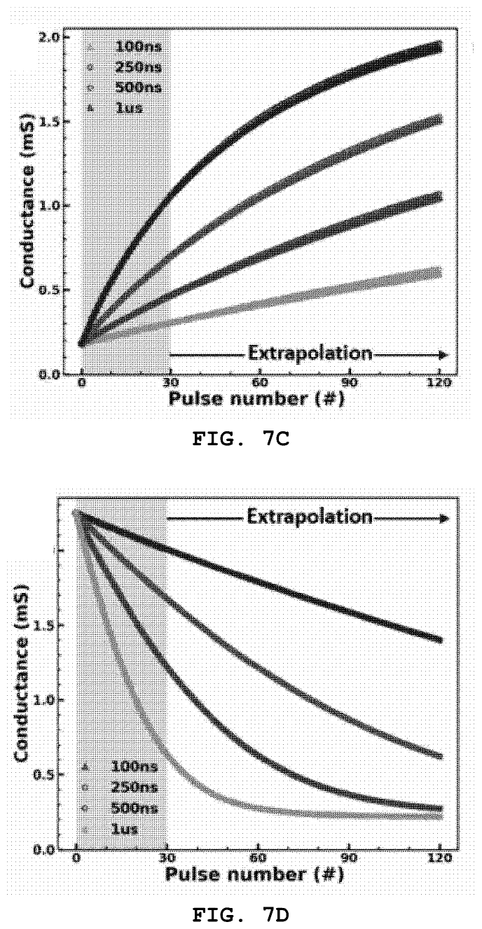

FIGS. 7A, 7B, 7C, and 7D are graphs showing a conductance prediction for an input voltage pulse of a neural network according to an embodiment of the present invention. In FIGS. 7A to 7D, the lines represent LTP and LTD for the prediction of the neural network. In FIGS. 7A to 7D, the triangles represent training data, and circles represent test data. In FIGS. 7A and 7B, the amplitudes of the input voltage pulses are different from each other. In FIGS. 7C and 7D, the pulse widths are different from each other. The shaded areas represent observed areas, and the unshaded areas represent the extrapolation areas.

FIGS. 7A to 7D show the test results of the neural network 300 for serial input voltage pulses under 120 different pulse conditions. The graphs in FIGS. 7A to 7D show accurate predictions of LTP and LTD characteristics for each voltage pulse that is more than four times the observed period. In FIGS. 7C and 7D, the input pulse voltage has a fixed rise/fall time of 25 ns, and the pulse width is variable. In FIG. 7C, the set voltage Vset is 1.05 V, and in FIG. 7D, the reset voltage Vreset is −2.3 V.

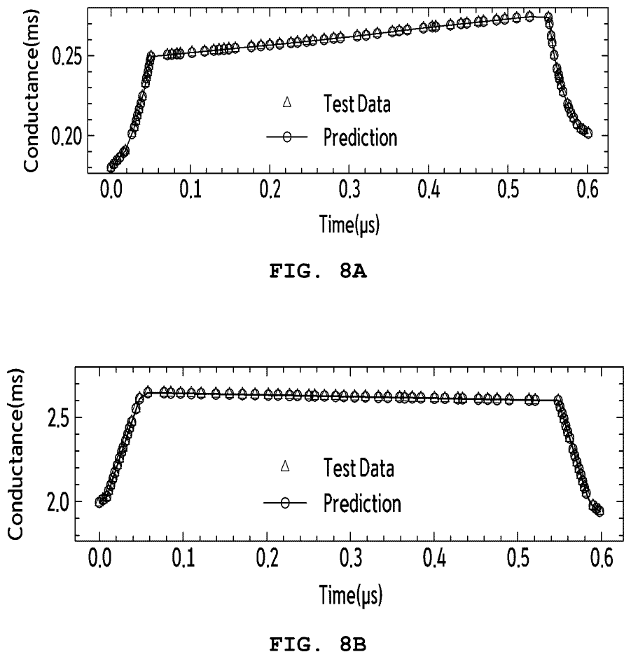

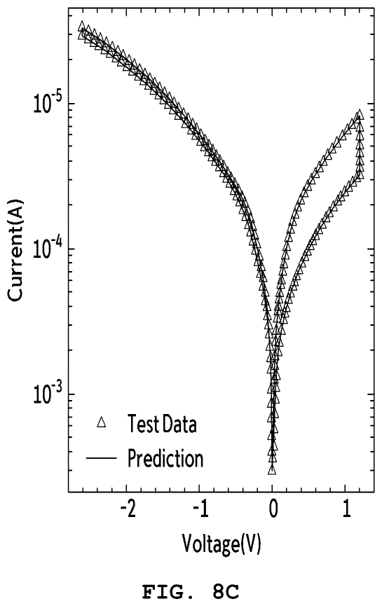

FIGS. 8A, 8B, and 8C are other graphs showing a conductance prediction for time of a neural network according to an embodiment of the present invention. FIG. 8A is a graph showing test data irregularly sampled from a positive voltage pulse and the prediction result of a neural network. FIG. 8B is a graph showing test data irregularly sampled from a negative voltage pulse and the prediction result of a neural network. FIG. 8C is a graph showing the relationship between voltage and current characteristics according to test data and the prediction of a neural network.

Referring to FIGS. 8A and 8B, the neural network 300 for processing a non-uniform time interval is evaluated. In FIG. 8A, the test data is 80 pieces of data randomly selected from an input voltage pulse with a width of 500 ns, a rise/fall time of 50 ns, and a set voltage Vset of 1.05 V. In FIG. 8B, the test data is 80 pieces of data randomly selected from an input voltage pulse with a width of 500 ns, a rise/fall time of 50 ns, and a reset voltage Vreset of −2.3 V.

The linear error of the conductance for the voltage pulse of the neural network 300 in FIG. 8A is 0.32%, and in FIG. 8B is 0.08%.

In FIG. 8C, the linear error of the conductance for the voltage pulse of the neural network 300 in the input voltage pulse with a width of 1 μs, a rise/fall time of 100 ns, a set voltage Vset of 1.2 V, and a reset voltage Vreset of −2.6 V is 0.27%.

The internal state of the RRAM device is approximated by the ODE layer 420, thereby implementing the LTP and LTD with high accuracy. In addition, the input voltage that changes over time can be applied to the GRU cell to replace an equation-based compact model.

The neural network 300 may predict not only the conductance after the input voltage pulse is applied, but also a change in the conductance characteristics according to the change in the input voltage in real time. Therefore, the compact modeling method for a memory using the neural network 300 can replace the equation-based compact model.

The data-driven compact model for an RRAM device using a neural network has the effect of accurately predicting LTD and LTD characteristics under various input voltage pulse conditions. In addition, the data-driven compact model for an RRAM device using the neural network has the effect of accurately performing voltage-conductance data processing at non-uniform time steps, which is an important requirement in compact models.

As described above, the compact modeling method and computing device for a memory using a neural network according to an embodiment of the present invention have the effect of effectively processing long serial data using a GRU.

In addition, the compact modeling method and computing device for a memory using a neural network according to an embodiment of the present invention have the effect of approximating the continuous dynamics of the internal state of an RRAM device by applying an ODE technique implemented with a neural network algorithm, thereby predicting LTP and LTD characteristics for various input voltage conditions.

Although the present invention has been described with reference to embodiments shown in the drawings, this is merely exemplary, and those skilled in the art will understand that various modifications and equivalent other embodiments are possible therefrom. Therefore, the true technical protection scope of the present invention should be determined from the technical idea of the appended claims.

What is claimed is:

1. A compact modeling method for a memory using a neural network performed by a processor, the compact modeling method comprising:
updating a hidden state at time tₙ₊₁ by applying a voltage of the memory, a conductance of the memory, and the hidden state approximated at time tₙ₊₁ to a gated recurrent unit (GRU) cell; and
predicting a conductance of the memory at time tₙ₊₁ by applying the voltage, the conductance, and the updated hidden state to a multilayer perceptron (MLP).

2. The compact modeling method of claim 1, further comprising approximating an instantaneous change in the hidden state of the neural network used in compact modeling for the memory by applying a voltage of the memory at time tₙ₊₁ and a conductance of the memory at time tₙ to a fully connected layer.

3. The compact modeling method of claim 2, wherein the conductance predicted at time tₙ₊₁ is applied to the fully connected layer at a next time step.

4. The compact modeling method of claim 1, further comprising generating input training data by randomly sampling an input pulse voltage at irregular time intervals in an arbitrary number of samplings in a width and rise/fall time of the input pulse voltage to train the neural network.

5. The compact modeling method of claim 1, wherein the memory is a resistive random access memory (ReRAM).

6. A computing device comprising:
a processor configured to execute compact modeling commands for a resistive random access memory (ReRAM) using a neural network; and
a memory configured to store the commands,
wherein the commands are implemented to:
update a hidden state at time tₙ₊₁ by applying a voltage of the ReRAM, a conductance of the ReRAM, and the hidden state approximated at time tₙ₊₁ to a GRU cell; and
predict a conductance of the ReRAM at time tₙ₊₁ by applying the voltage, the conductance, and the updated hidden state to an MLP.

7. The computing device of claim 6, wherein the commands are further implemented to approximate an instantaneous change in the hidden state of the neural network used in the compact modeling for the ReRAM by applying a voltage of the memory at time tₙ₊₁ and a conductance of the ReRAM at time tₙ to a fully connected layer.

8. The computing device of claim 7, wherein the conductance predicted at time tₙ₊₁ is applied to the fully connected layer at a next time step.

9. The computing device of claim 6, wherein the commands are further implemented to generate input training data by randomly sampling an input pulse voltage at irregular time intervals in an arbitrary time of samplings in a width and rise/fall time of the input pulse voltage to train the neural network.

10. The computing device of claim 6, wherein the neural network includes:
an input layer including a voltage of the ReRAM at time tₙ₊₁ and a conductance of the ReRAM at time tₙ;
a hidden layer including the GRU cell; and
an output layer including the conductance of the ReRAM at time tₙ₊₁.
